(19) United States
(12) Patent Application Publication
(10) Pub. No.: US 2025/0274023 A1
(43) Pub. Date: Aug. 28, 2025

(54) SYSTEM WITH AN ELECTRIC ROTARY TRANSFORMER

(71) Applicant: MAHLE International GmbH, Stuttgart (DE)

(72) Inventors: Thorsten Grelle, Stuttgart (DE); Peter Kozlowski, Stuttgart (DE); Penyo Topalov, Stuttgart (DE); Philipp Zimmerschied, Stuttgart (DE)

(21) Appl. No.: 18/704,915

(22) PCT Filed: Oct. 20, 2022
(86) PCT No.: PCT/EP2022/079273

§ 371 Date: Apr. 25, 2024

(30) Foreign Application Priority Data
Oct. 27, 2021 (DE) 10 2021 212 148.9

(51) Int. Cl. H02K 19/12; H01F 38/18; H02J 50/10; H02K 11/35

(52) U.S. Cl. CPC H02K 19/12; H01F 38/18; H02J 50/10; H02K 11/35

(57) ABSTRACT

An externally excited electric synchronous machine may include a machine rotor, a machine stator, and a system including an electric rotary transformer for inductive energy transmission. The rotary transformer may include (i) a rotary transformer stator with a transformer primary coil and (ii) a rotary transformer rotor with a transformer secondary coil. The transformer coils may interact inductively to provide a transformer voltage in the transformer secondary coil. A rotor coil of the machine rotor may be connected to the transformer secondary coil and may be supplied with a direct voltage. The system may include a signal transmission device for transmitting operating signals with the rotary transformer rotor. The signal transmission device may include a rotor signalling coil and a stator signalling coil that interact inductively for signal transmission. The stator signalling coil and the rotor signalling coil may be electrically isolated from the transformer primary and secondary coil, respectively.

### CROSS-REFERENCE TO RELATED APPLICATIONS

This application claims priority to International Patent Application No. PCT/EP2022/079273, filed on Oct. 20, 2022, and German Patent Application No. DE 10 2021 212 148.9, filed on Oct. 27, 2021, the contents of both of which are hereby incorporated by reference in their entirety.

### TECHNICAL FIELD

The present invention relates to an externally excited electric synchronous machine with a system with an electric rotary transformer for an inductive energy transmission. In addition, the invention relates to a motor vehicle with such a synchronous machine. The invention relates furthermore to the use of such an externally excited electric synchronous machine as a traction motor.

### BACKGROUND

An electric rotary transformer is used for inductive energy transmission. For this purpose, the rotary transformer has a primary coil and a secondary coil. The primary coil is usually stationary, whereas the secondary coil is movable, in particular rotatable, relative to the primary coil. For this purpose, such a rotary transformer usually has a stationary stator and a rotor which is rotatable relative to the stator about a rotation axis. The stator of the rotary transformer, also designated in the following as rotary transformer stator, usually has the primary coil, which is also designated in the following as transformer primary coil. The rotor of the rotary transformer, also designated in the following as rotary transformer rotor, usually has the secondary coil, which is also designated in the following as transformer secondary coil.

Such a rotary transformer is used in an externally excited electric synchronous machine. The externally excited electric synchronous machine has a stationary stator and a rotor rotating during operation relative to the stator about a rotation axis, which are also designated in the following as machine stator and machine rotor. In so doing, a magnetic rotor field of the machine rotor and a magnetic stator field of the machine stator interact. In the externally excited electric synchronous machine, the required rotor field of the machine rotor is externally excited. For this purpose, the machine rotor generally has a rotor coil, which is supplied with a direct current for generating the magnetic field. The supplying of the rotor coil can take place by means of the rotary transformer.

Such a synchronous motor with a rotary transformer is known for example from EP 2 869 316 B1. During operation, the transformer primary coil induces a voltage in the transformer secondary coil.

Further externally excited synchronous machines are known from DE 10 2017 214 766 A1, DE 10 2013 209 216 A1 and from WO 02/067276 A1.

Usually, the rotary transformer stator and rotary transformer rotor are coordinated with one another such that a desired voltage is induced in the transformer secondary coil. Changes in the coordination can thus lead to deviations of the induced voltage. Also, desired or necessary changes of the induced voltage, in particular of the current flowing through the rotor coil, can thus not be implemented, or only implemented with difficulty.

### SUMMARY

The present invention is therefore concerned with the problem of indicating, for an externally excited electric synchronous machine of the type mentioned in the introduction and for a motor vehicle with such a synchronous machine, improved or at least different embodiments which eliminate disadvantages of solutions known from the prior art. In particular, the present invention is concerned with the problem of indicating, for the externally excited electric synchronous machine and for the motor vehicle, embodiments which are distinguished by an increased operational stability.

This problem is solved according to the invention by the subject matter of the independent claim(s). Advantageous embodiments are the subject matter of the dependent claim(s).

The present invention is thus based on the general idea of providing, in an externally excited electric synchronous machine a system with an electric rotary transformer, and an inductive signal transmission at the electric rotary transformer by which, with a rotor of the rotary transformer, operating signals of the rotary transformer and/or the externally excited synchronous machine, can be transmitted, in particular exchanged. Consequently it is possible in a simple and effective manner to provide at the rotary transformer, in particular in the rotor of the rotary transformer, operating signals and thus operating states or respectively to transmit these from the rotor. In particular, a wired signal transmission between the rotor, rotating relative to the stator during operation, can thus be dispensed with. Consequently, the operation of the rotary transformer and of the associated application can be adapted in a simple manner depending on said operating states and/or disturbances during operation can be detected in a simplified manner. The result is an improved operational stability of the rotary transformer and/or of the associated application. The inductive signal transmission is used here additionally for the inductive energy transmission in the rotary transformer.

In accordance with the inventive idea, the externally excited electric synchronous machine comprises the system which comprises the electric rotary transformer. For inductive energy transmission, the electric rotary transformer has a primary coil and a secondary coil, which are also designated in the following as transformer primary coil and transformer secondary coil. In addition, the rotary transformer has a stationary stator, also designated in the following as rotary transformer stator, and a rotor, also designated in the following as rotary transformer rotor.

The rotary transformer stator comprises the transformer primary coil. The rotor transformer rotor comprises the transformer secondary coil. The rotary transformer rotor is rotatable relative to the rotary transformer stator about an axially running rotation axis. During operation, the rotary transformer rotor thus rotates relative to the rotary transformer stator about the rotation axis. For an inductive energy transmission and thus during operation, the transformer primary coil and the transformer secondary coil interact to generate an electric voltage in the transformer secondary coil inductively, wherein the voltage is also designated in the following as transformer voltage. Furthermore, the system has a signal transmission device for the inductive transmitting of operating signals with the rotary transformer rotor. The signal transmission device has a coil which is rotationally fixed to the rotary transformer rotor, which coil is also designated in the following as rotor signalling coil. The signal transmission device has, in addition, a coil which is stationary relative to the rotary transformer stator, which coil is also designated in the following as stator signalling coil. The stator signalling coil and the rotor signalling coil interact inductively during operation for signal transmission. Here, the stator signalling coil is electrically isolated from the transformer primary coil. In addition, the rotor signalling coil is electrically isolated from the transformer secondary coil.

The directions which are indicated here relate to the axially running rotation axis. Accordingly, “axial” runs parallel, in particular coaxial, to the rotation axis. In addition, “radial” runs transversely to the rotation axis.

The transformer secondary coil and the transformer primary coil are advantageously arranged lying axially opposite. It is also conceivable to arrange the transformer secondary coil and the transformer primary coil in a radially adjacent manner, in particular lying opposite.

Advantageously, the stator signalling coil and the rotor signalling coil are arranged lying axially opposite. It is also conceivable to arrange the stator signalling coil and the rotor signalling coil in a radially adjacent manner, in particular lying opposite.

Advantageously, the rotor signalling coil is spaced apart from the transformer secondary coil. The rotor signalling coil is preferably spaced apart from the transformer secondary coil radially, advantageously radially inwardly. Advantageously the stator signalling coil is spaced apart from the transformer primary coil. Preferably, the stator signalling coil is spaced apart from the transformer primary coil radially, advantageously radially inwardly. Couplings between the transformer coils, i.e. the transformer primary coil and the transformer secondary coil, and the signalling coils, are thus prevented or at least reduced.

Advantageously, the transformer secondary coil runs surrounding the rotation axis, in particular in a spiral-shaped manner. In particular, the transformer secondary coil is configured as a planar winding.

Advantageously, the rotor signalling coil runs surrounding the rotation axis, in particular in a circular or spiral-shaped manner.

Advantageously, the transformer primary coil runs surrounding the rotation axis. In particular, the transformer primary coil is configured as a flat coil.

Advantageously, the inductive interaction of the transformer primary coil with the transformer secondary coil on the one hand, and the inductive interaction of the stator signalling coil with the rotor signalling coil on the other hand, are implemented at different frequencies. Thus in particular reciprocal influences of the inductive interactions are prevented or at least reduced.

The signal transmission is preferably implemented at a higher frequency than the inductive energy transmission for inducing the transformer voltage. The inductive energy transmission can thus be operated with a low frequency and an increased output, the signal transmission with a high frequency and low output. As a result, the system is operated effectively with high output and, at the same time, a reliable and efficient signal transmission is achieved.

The stator signalling coil is preferably mounted securely on the rotary transformer stator. Thus, during operation, operating signals are transmitted between the rotary transformer rotor and the rotary transformer stator by means of the signal transmission device.

Embodiments are preferred in which the transformer secondary coil is configured surrounding the rotation axis and in an axially flat manner.

Embodiments are advantageous in which the rotary transformer rotor has a circuit board which is provided with the transformer secondary coil. Thus, a simple configuration of the rotary transformer rotor and a simple and precise mounting and arrangement of the transformer secondary coil are brought about.

It is also conceivable to embody the transformer secondary coil as a cast coil.

Embodiments are preferred in which the transformer secondary coil has at least one conductor track of the circuit board, which is also designated in the following as transformer conductor track. This leads to a simplified configuration and production of the rotary transformer. Furthermore, the transformer secondary coil is configured in this way in a simplified manner and/or mechanically stabilized.

It is particularly preferred here if the transformer secondary coil is formed by at least one transformer conductor track of the circuit board, therefore consists of at least one transformer conductor track of the circuit board.

The circuit board is advantageously configured in an axially flat manner. The circuit board is thus space-saving and reduced in weight.

Particularly preferably, the circuit board is round in axial top view, for example configured as a disc or as a ring.

Embodiments are deemed to be advantageous in which the rotor signalling coil has at least one conductor track of the circuit board, which to differentiate from the at least one transformer conductor track, is also designated in the following as signal conductor track. This means that the rotor signalling coil also has at least one conductor track of the circuit board and is electrically isolated from the transformer secondary coil. This leads to a simplified production of the rotary transformer and to a precise arrangement of the rotor signalling coil.

The rotor signalling coil is preferably formed by at least one signal conductor track of the circuit board. The rotor signalling coil therefore consists of the at least one signal conductor track. The rotor signalling coil is thus configured in a simplified manner and/or is stabilized in a precisely positionable and/or mechanical manner.

The respective at least one transformer conductor track and/or signal conductor track can be arranged on the circuit board and can thus be visually perceptible from the exterior, or surrounded within the circuit board and thus not visually perceptible from the exterior. Of course, embodiments are possible in which both at least one conductor track is arranged on the circuit board and at least one conductor track is arranged within the circuit board. The circuit board can therefore be configured in particular as a circuit board known for the specialist in the art as a “multilayer circuit board”.

The transformer secondary coil can have at least two transformer conductor tracks spaced apart from one another axially. Preferably, the transformer conductor tracks run parallel to one another here.

Embodiments are conceivable in which at least one transformer conductor track is arranged on the circuit board and at least one transformer conductor track is arranged within the circuit board.

The signal transmission device advantageously has a unit, rotationally fixed to the rotary transformer rotor, for the processing of operating signals received by means of the rotor signalling coil, which is also designated in the following as rotor signalling unit. The rotor signalling unit is downstream in receiving direction of the rotor signalling coil.

Embodiments are advantageous in which an electric filter is connected between the rotor signalling coil and the rotor signalling unit, for filtering the operating signal which is received by means of the rotor signalling coil. Thus in particular possible disturbances of the operating signal, which can be caused for example by the transformer coils, are filtered. Consequently, an increased quality of the signal transmission and/or an improved operational stability of the rotary transformer is brought about.

The rotor signalling unit and/or the filter are preferably provided on the circuit board.

The signal transmission device advantageously has a unit for the processing of operating signals received by means of the stator signalling coil, which is also designated in the following as stator signalling unit. The stator signalling unit is fixed relative to the rotary transformer stator and is thus stationary. The stator signalling unit is downstream of the stator signalling coil in receiving direction.

Advantageously, an electric filter is connected between the stator signalling coil and the stator signalling unit for filtering the operating signal received by means of the stator signalling coil. Thus in particular, possible disturbances of the operating signal, which can be caused for example by the transformer coils, are filtered. Consequently, an increased quality of the signal transmission and/or an improved operational stability of the rotary transformer is brought about.

Advantageously, at least one of the signalling units, preferably the respective signalling unit, is also configured for generating an operating signal and/or a signal containing at least one operating state. This means that advantageously at least one of the signalling units, preferably the respective signalling unit, is also configured for sending an operating signal by means of the associated signalling coil.

Embodiments are preferred in which the transformer coils are arranged in a magnet core which is stationary relative to the rotary transformer stator. Thus, an improved inductive interaction of the transformer coils with one another is brought about. The magnet core, also designated in the following as transformer magnet core, can basically be configured in any desired manner. In particular, the magnet core concerns a ferrite body.

Advantageously, the transformer magnet core has an axially open recess for the transformer primary coil.

Advantageously, the transformer magnet core is radially open, so that the transformer secondary coil, in particular the circuit board, penetrates radially into the transformer magnet core and is rotatable in the transformer magnet core.

It is conceivable to also arrange the stator signalling coil and/or the rotor signalling coil in the transformer magnet core. Here, the rotor signalling coil is expediently arranged rotatably in the transformer magnet core. A simple configuration of the rotary transformer is thus brought about.

It is conceivable to arrange the stator signalling coil and the rotor signalling coil in a signal magnet core which is spaced apart radially with respect to the transformer magnet core. Thus, magnetic couplings of the signalling coils with the transformer coils are prevented or at least reduced. In this way, an improved transmission of the operating signals and reduced disturbances of the operating signals are brought about.

Advantageously, the signal magnet core is stationary, i.e. is stationary relative to the rotary transformer stator.

The signal magnet core can also concern any desired magnet core. In particular, the signal magnet core is a ferrite body.

Advantageously, the signal magnet core is spaced apart radially inwardly with respect to the transformer magnet core. Preferably, the signal magnet core has a radial duct here, through which the circuit board is radially directed.

The system can have a rectifier circuit downstream of the transformer secondary coil. Thus, the transformer voltage which is induced in the transformer secondary coil as alternating voltage can be converted into a direct voltage and can be made available for an associated application.

The system can have an inverter circuit upstream of the transformer primary coil. Thus, the alternating voltage for the transformer primary coil which is required during operation can originate from an electrical energy source which provides a direct voltage.

The system can basically be used in any desired applications for inductive energy transmission.

The synchronous machine has a rotor with a rotor shaft, wherein the rotor is also designated in the following as machine rotor. The machine rotor has at least one coil, provided in a rotationally fixed manner on the rotor shaft, which is also designated in the following as machine rotor coil. The at least one machine rotor coil generates during operation, on supplying with a direct voltage and thus with a direct current, a magnetic field which is also designated in the following as rotor field. The synchronous machine has, furthermore, a stationary stator, which is also designated in the following as machine stator. The machine stator has at least one coil which is also designated in the following as machine stator coil. The at least one machine stator coil generates during operation a magnetic field which is also designated in the following as stator field. During operation of the synchronous machine, the stator field interacts with the rotor field such that the machine rotor rotates about the axial rotation axis. Here, the rotary transformer stator is stationary relative to the machine stator. In addition, the rotary transformer rotor is mounted in a rotationally fixed manner to the machine rotor. In particular, the rotary transformer rotor is connected to the rotor shaft in a rotationally fixed manner. The at least one machine rotor coil is connected to the transformer secondary coil such that the at least one machine rotor coil is supplied during operation with a direct voltage or respectively a direct current for generating the rotor field. For this purpose, advantageously a rectifier circuit is connected between the transformer secondary coil and the at least one machine rotor coil. Which rectifier circuit, as mentioned above, can be a component part of the system.

Preferably, the rotary transformer, in particular the rotary transformer rotor, is arranged axially on the face side of the machine rotor. Particularly preferably, the rotary transformer is spaced apart with respect to the machine rotor coil and/or to the machine stator coil. Thus, a prevention or at least reduction of undesired interactions between the rotary transformer and the rotor field and/or the stator field is brought about.

The operating signal expediently contains information concerning an operating state of the rotary transformer and/or of the associated application, in particular concerning the synchronous machine. The respective operating state can concern for example a voltage applied at the at least one machine rotor coil and/or an electric current flowing through the at least one machine rotor coil. The operating signal can likewise be a trigger signal for protective circuits at the rotary transformer rotor and/or at the machine rotor. Likewise, the operating signal can be a temperature, for example at least of one of the at least one machine rotor coils. Of course it is also possible to transmit two or more operating states with the operating signal.

The alternating voltage required for the transformer primary coil can originate from any desired electrical energy source.

It is conceivable in particular that the energy source provides a direct voltage. In particular, the energy source can concern a battery. Here, expediently an inverter circuit is provided between the energy source and the transformer primary coil, which inverter circuit convers the direct voltage into the required alternating voltage. The inverter circuit, as mentioned above, can be a component part of the rotary transformer here.

The synchronous machine can basically be used in any desired applications.

In particular, the synchronous machine can be used as a traction motor.

The synchronous machine is used in particular in a motor vehicle which can comprise a battery as energy source. Here, the synchronous machine serves in particular for the drive of the motor vehicle, is therefore a traction motor of the motor vehicle. Preferably, the traction motor according to the invention has an output power or respectively drive power between 100 kW and 240 kW, in particular 140 kW.

The traction motor advantageously delivers a performance of between 100 KW and 240 kW, in particular of 140 kW.

It shall be understood that in addition to the rotary transformer, the externally excited electric synchronous machine and the motor vehicle respectively also belong to the handling of the present invention.

Further important features and advantages of the invention will emerge from the subclaims, from the drawings and from the associated figure description with the aid of the drawings.

It shall be understood that the features mentioned above and to be explained further below are able to be used not only in the respectively indicated combination but also in other combinations or in isolation, without departing from the scope of the present invention.

Preferred example embodiments of the invention are illustrated in the drawings and are explained more closely in the following description, wherein the same reference numbers refer to identical or similar or functionally identical components.

### BRIEF DESCRIPTION OF THE DRAWINGS

There are shown, respectively schematically,

FIG. 1 shows a highly simplified circuit diagram of an externally excited electric synchronous machine with a system which comprises an electric rotary transformer, in a motor vehicle,

FIG. 2 shows a section through the rotary transformer,

FIG. 3 shows a section through the rotary transformer in another example embodiment,

FIG. 4 shows an isometric view, partially in section, of a machine rotor of the externally excited electric synchronous machine with the rotary transformer,

FIG. 5 shows a highly simplified section through the externally excited electric synchronous machine.

### DETAILED DESCRIPTION

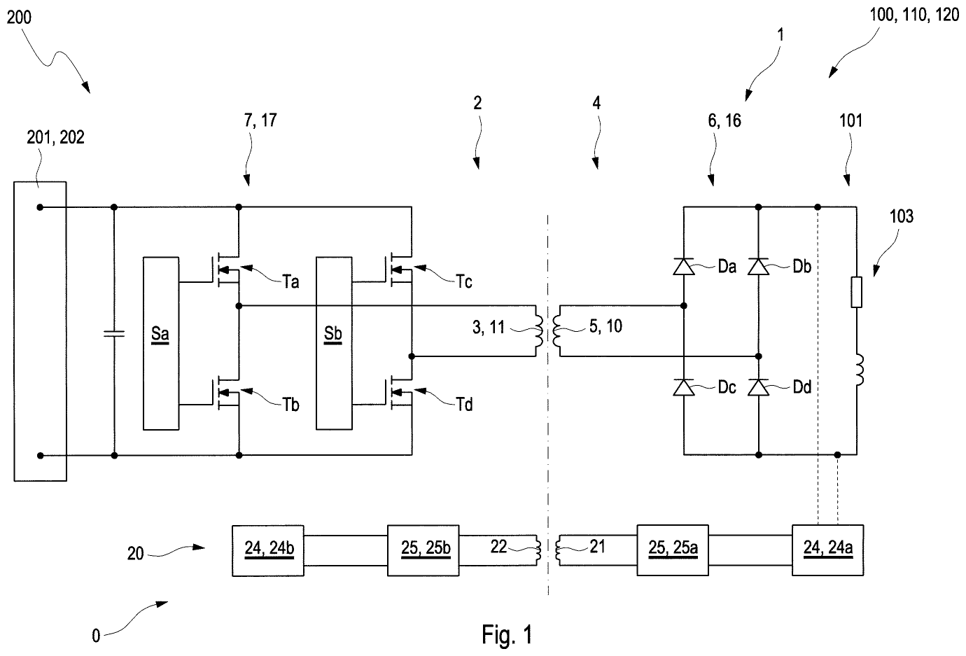

A system 0, as is shown for example in FIGS. 1 to 4, has an electric rotary transformer 1 as inductive energy transmitter. The system 0 is used in an externally excited electric synchronous machine 100 shown in the FIGS. 1 to 5. The synchronous machine 100 can be used in a motor vehicle 200, as is shown in a highly simplified manner in FIG. 1. The externally excited electric synchronous machine 100 can be used as a synchronous motor 110, in particular for driving the motor vehicle 200. The externally excited electric synchronous machine 100 can therefore be used in particular as a traction motor 120. For this, the traction motor 120 can deliver for example a performance of between 100 kW and 240 kW, in particular of 140 kW.

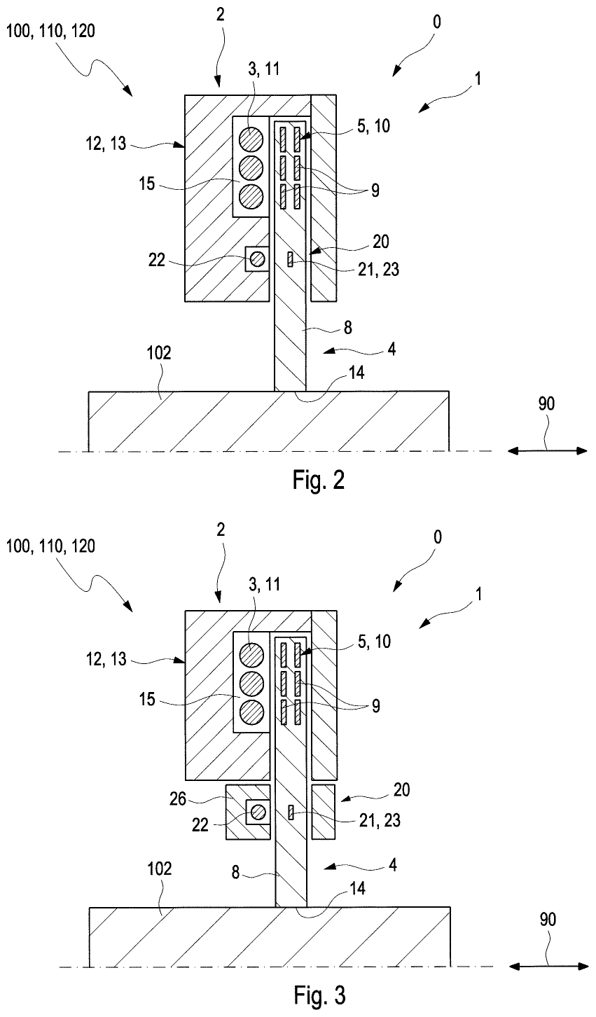

As can be seen from FIGS. 1 to 4, the rotary transformer 1 has a stator 2 and a rotor 4. The stator 2 is designated in the following as rotary transformer stator 2. The rotor 4 is designated in the following as rotary transformer rotor 4. The rotary transformer rotor 4 is rotatable relative to the rotary transformer stator 2 about an axially running rotation axis 90. During operation, the rotary transformer rotor 4 therefore rotates relative to the rotary transformer stator 2 about the rotation axis 90. For inductive energy transmission, the rotary transformer stator 2 has a primary coil 3, and the rotary transformer rotor 4 has a secondary coil 5. The primary coil 3 and the secondary coil 5, as can be seen from FIGS. 2 to 4, are arranged lying axially opposite in the example embodiments which are shown. During operation, the primary coil 3, which is also designated in the following as transformer primary coil 3, induces in the secondary coil 5, which is designated in the following as transformer secondary coil 5, an alternating voltage, which is also designated in the following as transformer voltage.

The directions which are indicated here refer to the rotation axis 90. Accordingly, “axially” runs parallel to the rotation axis. In addition, “radially” runs transversely to the rotation axis 90.

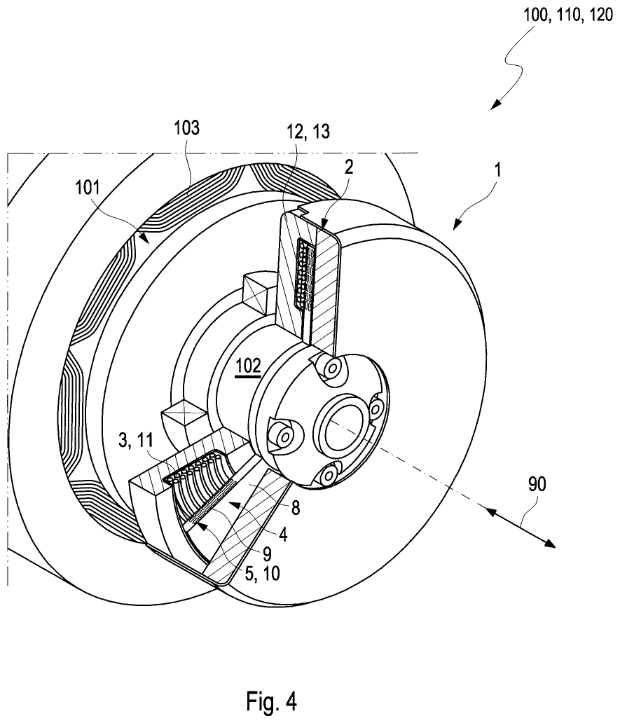

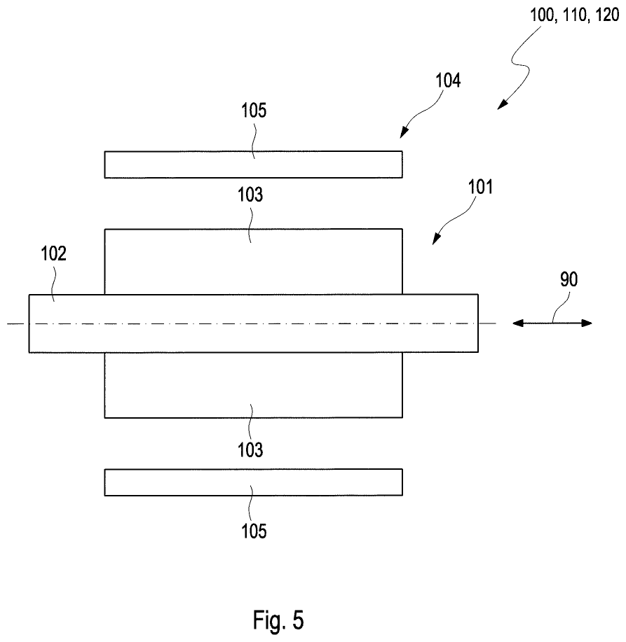

The externally excited electric synchronous machine 100, also abbreviated in the following as synchronous machine 100, has a rotor 101, as can be seen in particular from FIGS. 4 and 5. The rotor 101 is also designated in the following as machine rotor 101. The machine rotor 101 has a rotor shaft 102 and at least one coil 103, provided in a rotationally fixed manner at the rotor shaft 102 (see FIG. 1). The coil 103 is also designated in the following as machine rotor coil 103. The machine rotor coil 103 is symbolised in FIG. 1 as an inductance and an ohmic resistance. The machine rotor 101 can also have two or more machine rotor coils 103, wherein in the following for the sake of simplicity one machine rotor coil 103 is assumed. During operation, the machine rotor coil 103 generates a magnetic field, which is also designated in the following as rotor field. The synchronous machine 100 has, furthermore, a stator 104, shown in a simplified manner in FIG. 5, which is also designated in the following as machine stator 104. In addition, the synchronous machine 100 has at least one coil 105, stationary relative to the machine stator 104 (see FIG. 5), which is also designated in the following as machine stator coil 105. During operation, the at least one machine stator coil 105 generates a magnetic field, which is also designated in the following as stator field. Here, the stator field and rotor field interact so that the machine rotor 101 rotates about the rotation axis 90 during operation. To generate the rotor field, the machine rotor 101, in particular the machine rotor coil 103, requires a direct voltage. In the example embodiments which are shown, this direct voltage is delivered to the machine rotor coil 103 by means of the transformer secondary coil 5 and thus by means of the rotary transformer 1. For this purpose, as can be seen from FIG. 1, a rectifier circuit 6 is connected between the transformer secondary coil 5 and the machine rotor coil 103, which rectifier circuit converts the transformer voltage into the direct voltage. In addition, for this purpose, as can be seen from FIGS. 2 to 4, the rotary transformer rotor 4 is mounted in a rotationally fixed manner at the rotor shaft 102 and thus at the machine rotor 101. The rotary transformer rotor 4 thus rotates during operation with the rotor shaft 102 and consequently with the machine rotor 101 about the rotation axis 90. In addition, the rotary transformer stator 2 is fixed, and therefore stationary, relative to the machine stator 104. The rectifier circuit 6 can be a component part of the system 0 and can be rotationally fixed with the rotary transformer rotor 4.

As can be seen furthermore in particular from FIG. 4, in the example embodiments which are shown, the rotary transformer 1 is arranged at an axial face side of the machine rotor 101 and spaced apart with respect to the machine rotor coil 103 and the machine stator coil 105.

For inducing the transformer voltage in the transformer secondary coil 5, the transformer primary coil 3 requires an alternating voltage. As can be seen from FIG. 1, the transformer primary coil 3 in the example embodiments which are shown is supplied via an electrical energy source 201 which provides a direct voltage. The energy source 201 in the example embodiments which are shown concerns a battery 202 of the motor vehicle 200. To supply the transformer primary coil 3 with the alternating voltage, an inverter circuit 7 is provided between the energy source 201 and the transformer primary coil 3. The inverter circuit 7 converts the direct voltage of the energy source 201 into the alternating voltage for the transformer primary coil 3. It is conceivable here that the inverter circuit 7 comprises an inverter.

As can be seen from FIGS. 2 to 4, the rotary transformer rotor 4 in the example embodiments which are shown has a circuit board 8 which is provided with the transformer secondary coil 5. The circuit board 8 is configured in a disc-shaped manner and has a round shape, is therefore configured in the manner of a round disc or respectively a ring. In the example embodiments which are shown, the transformer secondary coil 5 has at least one conductor track 9 of the circuit board 8, which is also designated in the following as transformer conductor track 9. In the example embodiments which are shown, the transformer secondary coil 5 consists of the at least one transformer conductor track 9 and is configured as a planar winding 10. Here, as can be seen from FIGS. 2 and 3, the circuit board 8 in the example embodiments which are shown has two transformer conductor tracks 9, spaced apart axially with respect to one another, which surround the rotation axis 90 in a spiral-shaped manner. In addition, in the example embodiments which are shown, the at least one transformer conductor track 9 is arranged entirely in the circuit board 8.

The rotationally fixed connection of the rotor shaft 102 to the rotary transformer rotor 4 in the example embodiments which are shown, as can be seen from FIGS. 2 to 4, is realized via a central opening 14 in the circuit board 8 through which the rotor shaft 102 engages.

As can be seen from FIGS. 2 to 4, the transformer primary coil 3 in the example embodiments which are shown is configured as a flat coil 11. As can be seen furthermore from FIGS. 2 to 4, the transformer primary coil 3 and the transformer secondary coil 5 in the example embodiments which are shown are arranged in a magnet core 12, stationary relative to the rotary transformer stator 2, in particular in a ferrite core 13. The magnet core 12 is also designated in the following as transformer magnet core 12. The transformer magnet core 12 is open radially inwardly, so that the circuit board 9 with the transformer secondary coil 5 penetrates into the transformer magnet core 12 and is arranged rotatably therein. In addition, the transformer magnet core 12 has an axially open recess 15, in which the transformer primary coil 3 is arranged.

In the example embodiment shown in FIG. 1, the rectifier circuit 6 is configured, purely by way of example, as a bridge rectifier 16 with four diodes Da-d. In addition, the inverter circuit 7 is configured, purely by way of example, as a full bridge inverter 17, which has four transistors Ta-d and two driver circuits Sa, Sb for the transistors Ta-d.

As can be seen from FIG. 1, the system 0 has a signal transmission device 20 for transmitting operating signals with the rotary transformer rotor 4. For this purpose, the signal transmission device 20 has a coil 21 rotationally fixed to the rotary transformer rotor 4, and a coil 22 stationary relative to the rotary transformer stator 2, which interact inductively during operation for signal transmission. The coil 21 is also designated in the following as rotor signalling coil 21. The coil 22 is also designated in the following as stator signalling coil 22. Here, the transformer primary coil 3 is electrically isolated from the stator signalling coil 22, and the rotor signalling coil 21 is electrically isolated from the transformer secondary coil 5. In the example embodiments which are shown, the rotor signalling coil 21 and the stator signalling coil 22 are arranged lying axially opposite.

In the example embodiment which is shown, the signal transmission device 20 serves for the transmitting of operating signals between the rotary transformer rotor 4 and the rotary transformer stator 3. For transmitting an operating signal to the rotor signalling coil 21 and thus to the rotary transformer rotor 4, the stator signalling coil 22 thus induces an alternating voltage in the rotor signalling coil 21. For transmitting an operating signal to the stator signalling coil 22 and thus to the rotary transformer stator 3 or to the machine stator 3, the rotor signalling coil 21 induces an alternating voltage in the stator signalling coil 22. The respectively induced alternating voltage is also designated in the following as signal voltage. The signal voltage therefore contains respectively the operating signal, corresponds in particular to the operating signal. Of course, several operating signals can also be transmitted together or in succession.

With the operating signal it is possible in particular to adapt the rotary transformer 1 to the requirements of the synchronous motor 100. In particular, the rotor field can thus be changed more precisely and/or adapted more precisely. Likewise, with the operating signal, diagnostic values of the synchronous machine 100 and/or of the rotary transformer 1 can be transmitted and thus the operation of the synchronous machine 100 and/or of the rotary transformer 1 can be improved. The respective operating signal can concern in particular the voltage applied at the machine rotor coil 105 and/or an electric current flowing through the machine rotor coil 105. The operating signal can likewise be a trigger signal for protective circuits, not shown, at the rotary transformer rotor 4 and/or at the machine rotor 101, and/or a temperature, for example of the machine rotor coil 103.

As can be seen from FIGS. 2 and 3, the rotor signalling coil 21 can have at least one conductor track 23 of the circuit board 8, which is also designated in the following as signal conductor track 23. The at least one signal conductor track 23 is electrically isolated from the at least one transformer conductor track 9. The signal conductor track 23 can run in particular in a circular or spiral-shaped manner surrounding the rotation axis 90. In particular, the rotor signalling coil 21 is formed by at least one signal conductor track 23 of the circuit board 8. Here, the rotor signalling coil 21 in the example embodiments of FIGS. 2 and 3 has, by way of example, a single such signal conductor track 23. In the example embodiments shown in FIGS. 2 and 3, the signal conductor track 23 is arranged entirely within the circuit board 8.

As can be seen in particular from FIGS. 2 and 3, the rotor signalling coil 21 in the example embodiments which are shown is spaced apart radially with respect to the transformer secondary coil 5. In the example embodiments which are shown, the rotor signalling coil 21 is arranged offset radially inwardly with respect to the transformer secondary coil 5. Accordingly, the stator signalling coil 22 is also spaced apart radially with respect to the transformer primary coil 3, arranged offset radially inwardly in the example embodiments which are shown.

As can be seen from FIG. 1, the signal transmission device 20 has a unit 24, both on the rotor side and also on the stator side, for processing the respectively received operating signal, which is also designated in the following as signalling unit 24. The respective signalling unit 24 is downstream of the associated signalling coil 21. In addition, the signal transmission device 20 in the example embodiment which is shown has between the respective signalling unit 24 and the associated signalling coil 21, 22 an electric filter 25 for filtering the operating signal received by means of the associated signalling coil 21, 22. This means that the signal transmission device 20 has a rotor signalling unit 24a, rotationally fixed to the rotary transformer rotor 4, for processing an operating signal received by means of the rotor signalling coil 21, which is downstream of the rotor signalling coil 21. Between the rotor signalling coil 21 and the rotor signal unit 24a, an electric filter 25a is connected for filtering the operating signal received by means of the rotor signalling coil 21. Furthermore, the signal transmission device 20 has a stator signalling unit 24b, stationary relative to the rotary transformer stator 2, for processing an operating signal received by means of the stator signalling coil 22, which is downstream of the stator signalling coil 22. Between the stator signalling coil 22 and the stator signalling unit 24b, an electric filter 25b is connected for filtering the operating signal received by means of the stator signalling coil 22. In particular disturbances in the respectively received operating signal, in particular in the respective signal voltage, which can arise for example through magnetic couplings with the transformer primary coil 3 and/or with the transformer secondary coil 5, can thus be filtered out.

In the example embodiments which are shown, the respective unit 24 can also be configured for generating an operating signal which is transferred by means of the associated signalling coil 21, 22 to the other signalling coil 21, 22.

As indicated in FIG. 1, the rotor signalling unit 24a can pick up a voltage and/or a current between the rectifier circuit 6 and the machine rotor coil 103, in order for example to determine the voltage applied at the machine rotor coil 103 and/or the current flowing through the machine rotor coil 103 and to transmit is as operating signal. Likewise, the rotor signalling unit 24a can be supplied electrically in this way.

In the example embodiment of FIG. 2, the stator signalling coil 22 and the rotor signalling coil 21 are also arranged in the transformer magnet core 12.

The example embodiment of FIG. 3 differs herefrom in that the stator signalling coil 22 and the rotor signalling coil 21 are arranged in a signal magnet core 26 spaced apart radially with respect to the transformer magnet core 12. Possible magnetic couplings between the signal transmission device 20 and the transformer primary coil 3 and/or the transformer secondary coil 5 are thus at least reduced. Here, the signal magnet core 26 is advantageously stationary, therefore stationary relative to the rotary transformer stator 2. In the example embodiment which is shown, the signal magnet core 26 is arranged offset radially inwardly with respect to the transformer magnet core 12. Here, the circuit board 8 is directed radially through the signal magnet core 26.

1.-15. (canceled)

16. An externally excited electric synchronous machine, comprising:
a machine rotor including a rotor shaft and a machine rotor coil disposed in a rotationally fixed manner at the rotor shaft, the machine rotor coil providing a magnetic rotor field during operation;
a machine stator including a machine stator coil that is stationary relative to the machine stator, the machine stator coil providing a magnetic stator field during operation, which interacts with the magnetic rotor field such that the machine rotor rotates about an axial rotation axis during operation;
a system including an electric rotary transformer for an inductive energy transmission;
the rotary transformer including a rotary transformer stator with a transformer primary coil;
the rotary transformer further including a rotary transformer rotor which, during operation, rotates relative to the rotary transformer stator about an axially extending rotation axis, the rotary transformer rotor including a transformer secondary coil;
wherein, during operation, the transformer secondary coil and the transformer primary coil interact inductively to provide a transformer voltage in the transformer secondary coil;
wherein the rotary transformer stator is stationary relative to the machine stator;
wherein the rotary transformer rotor is mounted in a rotationally fixed manner at the machine rotor;
wherein the machine rotor coil is connected to the transformer secondary coil such that the machine rotor coil is supplied with a direct voltage for generating the magnetic rotor field;
wherein the system further includes a signal transmission device for transmitting operating signals with the rotary transformer rotor;
wherein the signal transmission device includes (i) a rotor signalling coil that is rotationally fixed with respect to the rotary transformer rotor and (ii) a stator signalling coil that is stationary relative to the rotary transformer stator, the rotor signalling coil and the stator signalling coil interacting inductively during operation for signal transmission; and
wherein the stator signalling coil is electrically isolated from the transformer primary coil, and the rotor signalling coil is electrically isolated from the transformer secondary coil.

17. The externally excited electric synchronous machine according to claim 16, wherein, during operation, the signal transmission device is operated with a lower frequency than the rotary transformer.

18. The externally excited electric synchronous machine according to claim 16, wherein the rotary transformer rotor includes a circuit board which is provided with the transformer secondary coil.

19. The externally excited electric synchronous machine according to claim 18, wherein the transformer secondary coil includes at least one transformer conductor track of the circuit board.

20. The externally excited electric synchronous machine according to claim 18, wherein the rotor signalling coil includes at least one signal conductor track of the circuit board.

21. The externally excited electric synchronous machine according to claim 16, wherein the rotor signalling coil is disposed spaced apart radially with respect to the transformer secondary coil.

22. The externally excited electric synchronous machine according to claim 16, wherein:
the signal transmission device includes a rotor signalling unit, which is rotationally fixed to the rotary transformer rotor, for processing an operating signal received via the rotor signalling coil;
the rotor signalling unit is arranged downstream of the rotor signalling coil; and
between the rotor signalling coil and the rotor signalling unit, an electric filter is connected for filtering the operating signal received via the rotor signalling coil.

23. The externally excited electric synchronous machine according to claim 16, wherein:
the signal transmission device includes a stator signalling unit, which is stationary relative to the rotary transformer stator, for processing an operating signal received via the stator signalling coil;
the stator signalling unit is arranged downstream of the stator signalling coil; and
between the stator signalling coil and the stator signalling unit, an electric filter is connected for filtering the operating signal received via the stator signalling coil.

24. The externally excited electric synchronous machine according to claim 16, wherein the transformer secondary coil and the transformer primary coil are arranged in a transformer magnet core that is stationary relative to the rotary transformer stator.

25. The externally excited electric synchronous machine according to claim 24, wherein the stator signalling coil and the rotor signalling coil are arranged in the transformer magnet core.

26. The externally excited electric synchronous machine according to claim 25, wherein the stator signalling coil and the rotor signalling coil are arranged in a signal magnet core that is disposed spaced radially with respect to the transformer magnet core.

27. The externally excited electric synchronous machine according to claim 16, wherein the rotary transformer rotor includes a rectifier circuit disposed downstream of the transformer secondary coil.

28. A motor vehicle, comprising a synchronous machine according to claim 16 and an electrical energy source, wherein the energy source is connected to the transformer primary coil via an inverter circuit.

29. A method of using an externally excited electric synchronous machine according to claim 16, comprising utilizing the synchronous machine as a traction motor.

30. An externally excited electric synchronous machine, comprising:
a machine rotor including a rotor shaft and a machine rotor coil, the machine rotor coil disposed on the rotor shaft in a rotationally fixed manner and providing a magnetic rotor field during operation;
a machine stator including a machine stator coil that is stationary relative to the machine stator, the machine stator coil providing a magnetic stator field during operation, which interacts with the magnetic rotor field such that the machine rotor rotates about an axial rotation axis during operation; and
a system including:
an electric rotary transformer for an inductive energy transmission; and
a signal transmission device;
the rotary transformer including:
a rotary transformer stator that is stationary relative to the machine stator, the rotary transformer stator including a transformer primary coil; and
a rotary transformer rotor that is mounted in a rotationally fixed manner at the machine rotor and rotatable relative to the rotary transformer stator about an axially extending rotation axis, the rotary transformer rotor including a transformer secondary coil arranged axially adjacent to the transformer primary coil;
the signal transmission device including:
a rotor signalling coil that is rotationally fixed with respect to the rotary transformer rotor; and
a stator signalling coil that is stationary relative to the rotary transformer stator, the rotor signalling coil and the stator signalling coil interacting inductively during operation for transmitting operating signals with the rotary transformer rotor;
wherein the stator signalling coil is electrically isolated from the transformer primary coil, and the rotor signalling coil is electrically isolated from the transformer secondary coil;
wherein the transformer secondary coil and the transformer primary coil interact inductively during operation to provide a transformer voltage in the transformer secondary coil; and
wherein the machine rotor coil is connected to the transformer secondary coil such that the machine rotor coil is supplied with a direct voltage for generating the magnetic rotor field.

31. The externally excited electric synchronous machine according to claim 30, wherein the rotary transformer is arranged adjacent to an axial face side of the machine rotor and is disposed spaced apart from the machine rotor coil and the machine stator coil.

32. The externally excited electric synchronous machine according to claim 30, wherein:
the rotary transformer rotor includes a circuit board; and
the transformer secondary coil is a planar winding and arranged entirely in the circuit board.

33. The externally excited electric synchronous machine according to claim 32, wherein:
the circuit board includes a central opening; and
the rotor shaft extends through the central opening of the circuit board.

34. The externally excited electric synchronous machine according to claim 30, further comprising a transformer magnet core, the transformer magnet core including:
an axially open recess in which the transformer primary coil is arranged; and
a radially inward open cavity in which the transformer secondary coil is arranged.

35. The externally excited electric synchronous machine according to claim 34, wherein the rotary transformer rotor includes a circuit board that projects radially into the cavity of the transformer magnet core and is rotatable within the cavity of the transformer magnet core.
